(19) United States
(12) Patent Application Publication
(10) Pub. No.: US 2022/0251820 A1
(43) Pub. Date: Aug. 11, 2022

(54) NORMALLY OPEN BACKWATER PREVENTION VALVE

(71) Applicant: Canplas Industries Ltd., Barrie (CA)

(72) Inventors: James Brian Mantyla, Barrie (CA); Scott Baldwin, Midhurst (CA)

(73) Assignee: Canplas Industries Ltd., Barrie (CA)

(21) Appl. No.: 17/586,905

(22) Filed: Jan. 28, 2022

(30) Foreign Application Priority Data
Feb. 5, 2021 (CA) 3108218

(51) Int. Cl. E03F 7/04; F16K 15/03; F16K 31/22

(52) U.S. Cl. CPC E03F 7/04; F16K 31/22; F16K 15/03

(57) ABSTRACT

A normally open backwater prevention valve for connecting to a sanitary drainpipe. The valve has an inflow end to connect to an upstream part of the drainpipe, and an out-flow end to connect to a downstream part of the drainpipe. There is a main body defining a flow through chamber extending between the inflow and the out-flow ends and a valve seat formed on an upstream side of the main body which faces downstream. A float assembly having opposed floats on opposite sides of the flow through chamber has a check valve assembly including at least a valve member located between the opposed floats. The valve member is sized and shaped to seal on the valve seat, and is operatively connected to the float assembly through a gear box. When the floats are down the valve member is in an open position and when the floats are up the valve member is moved to a closed position on the valve seat. Also provided is an access opening on a top of the flow through chamber, and a removable cover for sealing the access opening.

### CROSS-REFERENCE TO RELATED APPLICATIONS

This application claims the benefit of Canadian Application No. 3,108,218, filed Feb. 5, 2021, the contents of which is incorporated by reference herein.

### FIELD OF THE INVENTION

This invention relates generally to the field of plumbing products and more particularly to plumbing products for wastewater or sanitary sewer drainage systems, for example, from residential houses. Most particularly this invention relates to safety devices called backwater prevention valves which may be installed on a wastewater outflow drainpipe to try to prevent sewer water flowing in the wrong direction from a municipal sewer connection back up into a building, such as a residence.

### BACKGROUND OF THE INVENTION

Typically, in modern construction, indoor plumbing is provided in buildings which among other things, allows wastewater to be removed from inside of a building by means of a wastewater collection system. Usually, a source of fresh water is also provided to the building. The fresh water is supplied by means of a network of plumbing pipes which extend throughout the building and provide access to the fresh water through outlet valves, such as faucets, toilet valves and the like. A water heater may be provided to heat the fresh water, so that both hot and cold running water are provided within the building for the building occupants.

Used water, including both grey and black water, may be collected in a second network of plumbing pipes, known as a wastewater collection system. All the wastewater collected is typically directed to a single or main wastewater drain, which is then connected to a municipal wastewater system. Part of the wastewater collection system is one or more stack pipes which provides a means to vent for the wastewater system. The main drain is sloped so that, ideally, any wastewater collected within the building flows under the influence of gravity away from the building out through the drain to the municipal sewer system. The municipal wastewater system collects wastewater from many buildings and then, again mostly through gravity drainage, directs the wastewater to a municipal sewage treatment plant. The wastewater collected from many buildings is then treated at a central sewage treatment plant by various steps such as separation, digestion and aeration to render the treated wastewater safe for release back into the natural environment.

The gravity outflow connection through the main drain from the building to the gravity draining municipal wastewater system generally works very well. However, in some cases it can fail. Specifically, if there is a large enough water pressure in the gravity draining municipal water system beyond the residence, the direction of the flow of the wastewater can be reversed back into the building. Although rare, such wastewater backflow events can occur during a flash flood caused by a sudden and sever rainstorm or due to back up or other problem in the municipal sewer system. With climate change, sudden severe weather events seem to be becoming ever more common.

In a flooding event rather than the wastewater flowing out of the building, it can flow into the building if enough water pressure builds in the wastewater collection system outside of the building to reverse the flow direction. This may cause open wastewater connections within the building, such as sinks and toilets, to overflow with raw sewage. Raw sewage is unsanitary and incompatible with living spaces within the interior of a building. Such a backflow event is therefore highly undesirable. The interior of the building can suffer great damage to interior finishings, such as drywall, carpets and wooden floors as well as to possessions such as furniture. Basements, being the lowest part of the building usually suffer the most and typically also have other possessions stored therein which can also be damaged. Repairing the interior of the building after a sewer or wastewater back up event can be very expensive.

Consequently, back water prevention valves have been developed that can be inserted into the sewage outflow or drain line from the building which are designed to allow wastewater out of the building but in the event of a potential sewage back flow event, prevent any such sewage backflow from entering the building through the building wastewater system main drain. Typically, such backwater prevention valves take the form of a one-way valve that lets waste water flow out but prevents it from flowing back. However, a one-way valve that is normally closed prevents the municipal connection from being properly vented through the stack pipes. Thus, although potentially solving one problem, namely backflow, this type of valve creates another problem, namely inadequate venting.

One solution is to provide a normally open backwater valve. In this case it can be used to allow waste to drain out of the building and to prevent sewage from backing up into a building such as a home, through the sanitary outflow sewer pipe or drain and at the same time allow proper venting of the drainage connection. Many designs for normally open and closed backwater valves have been proposed in the past. Although the idea of a backwater valve has been known for a long time, they are only becoming more popular recently. Consequently, there are many older buildings which do not include such devices. However, it is still desirable to install such devices on existing sewer systems even in older homes. This can be a challenge. Typically, the sewage outlet flow is from a low point in the house in the basement and the main drain line is usually under the basement floor. To try to access the sewage outflow line outside of the footprint of the building requires excessive digging to reach the sewer line, which is expensive and impractical. For example, if the device ever required servicing, it would be rendered virtually inaccessible, if deeply buried underground outside of the building.

Therefore, it is usual to install a backwater prevention valve within the footprint of the building on the sewer main drain which is typically below the basement floor. Thus, in a retrofit installation, it may be necessary to break through a concrete basement floor to access the main drain line underneath. Due to the downward slope or grade of the drain line towards the municipal sewer connection the pipe may be somewhat below the level of the concrete basement floor, possibly even out of easy reach. This can make the installation and servicing of backwater prevention valves awkward because the device may be located fairly deeply within a hole below a concrete basement floor.

Some of the challenges for such a device include ensuring that the device is of a modest size to reduce the amount of concrete that needs to be removed and the size of the hole for a retrofit application. Further, the internal workings of the valve must be available for maintenance from time to time and should be readily accessible. As well the device should be designed to reliably close the sanitary drainpipe against a wastewater backflow event. Also, the device preferably remains open to allow proper stack pipe venting when in a normal outflow condition.

Some examples of the types of normally open backwater valves are set out in the prior patents and applications below.

U.S. Pat. No. 10,458,112

U.S. Pat. No. 9,903,106

U.S. Pat. No. 9,863,134

U.S. Pat. No. 9,027,593

U.S. Pat. No. 8,578,961

U.S. Pat. No. 7,152,622

U.S. Pat. No. 6,679,290

U.S. Pat. No. 6,446,665

U.S. Pat. No. 6,305,411

U.S. Pat. No. 6,247,489

U.S. Pat. No. 5,406,972

U.S. Pat. No. 2,928,410

U.S. Pat. No. 2,589,176

U.S. Pat. No. 1,864,443

U.S. Pat. No. 1,861,397

U.S. Pat. No. 993,587

U.S. Pat. No. 371,085

U.S. Pat. No. 305,722

U.S. Publication No. US-2004-0007265A1

German Patent No. 241,002

German Patent No. 222,224

German Patent No. 13,427

Great Britain Patent No. 1,005,862

### SUMMARY OF THE INVENTION

What is desired is a reliable design for a normally open backwater prevention valve that can be used in both retrofit and new construction applications and that can be easily accessible and simple to install and use. Most preferably such a device can be placed in a subgrade location on the outflow line of the wastewater pipe from a building, within the building footprint. Preferably the device will be easy to use, even if the subfloor location is below grade by an amount that is more than is easily reachable. Most preferably the device will have a small footprint to reduce the amount of digging required.

Therefore, according to one aspect the present invention provides a normally open backwater prevention valve for connecting to a sanitary drainpipe, said valve comprising:

an inflow end to connect to an upstream part of the drainpipe, and an out-flow end to connect to a downstream part of the drainpipe;

a main body defining a flow through chamber extending between said inflow and said out-flow ends;

a valve seat formed on an upstream side of said main body, said valve seat facing downstream;

a float assembly having opposed floats on opposite sides of the flow through chamber;

a check valve assembly including at least a valve member located between said opposed floats and being sized and shaped to seal on said valve seat, said check valve assembly further being operatively connected to said float assembly in a gear box wherein when said floats are down said valve member is in an open position and when said floats are up said valve member is in a closed position on said valve seat;

an access opening on a top of said flow through chamber; and

a removable cover for sealing said access opening. Preferably, the float assembly, check valve assembly and said gear box are sized and shaped to be readily removed from said flow through chamber through said opening.

According to another aspect of the present invention there is provided a normally open backwater prevention valve for connecting to a sanitary drainpipe, said valve comprising:

an inflow end to connect to an upstream part of the drainpipe, and an out-flow end to connect to a downstream part of the drainpipe;

a main body defining a flow through chamber extending between said inflow and said out-flow ends;

a valve seat formed on an upstream side of said main body, said valve seat facing downstream;

a float assembly having opposed floats on opposite sides of the flow through chamber;

a check valve assembly having a valve member located between said opposed floats and being sized and shaped to seal on said valve seat, said check valve assembly further being operatively connected to said float assembly wherein when said floats are down said valve member is in an open position and when said floats are up said valve member is in a closed position on said valve seat;

an opening on the top of said chamber; and

a removable cover for sealing and unsealing said opening;

wherein said float assembly, check valve assembly and said gear box are connected to said top when said top is in an open position and can be removed from said chamber by said connection.

### BRIEF DESCRIPTION OF THE DRAWINGS

Reference will now be made by way of example only to preferred embodiments of the invention by reference to the following drawing in which:

FIG. 1 is an exploded view of one embodiment of the present invention;

FIG. 2 is a top view of the components of the invention of FIG. 1 in an assembled position;

FIG. 3 is cross-sectional view of the invention of FIG. 2 along lines A-A;

FIG. 4 is an enlarged view of a portion of FIG. 3;

FIG. 5 is an end view of the invention of FIG. 1 in an assembled position;

FIG. 6 is a side cut away view of the embodiment of FIG. 1 in a normally open wastewater outflow condition;

FIG. 7 is a side cut away view of the embodiment of FIG. 6 in a backwater prevention condition;

FIG. 8 is a view of the interaction between an inverted T shaped post and a curved slot on the gear box of the previous figures; and

FIG. 9 is a view of one embodiment of the gear box of the previous figures in an assembled position for illustration purposes.

### DETAILED DESCRIPTION OF THE PREFERRED EMBODIMENTS

The present invention is described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein.

The preferred invention consists of a valve body 12 which defines a flow through chamber 14 and is provided with an access opening 16 which is closed by a cover 18. The cover 18 is secured to the access opening 16 preferably with a quarter turn connection and built-in keyways 20, 22 for both a round pipe and a two by four, for ease of access and use. The quarter turn connection reduces the chance of sand or dirt interfering with a good seal as might happen with a more fully threaded connection, and thus is preferred. The keyways enable simple on hand elements, such as pipes or two by fours to be used to extend a person's reach down to the installed device. An O-ring seal 19 is provided to ensure a good water tight fit between the cover 18 and the access opening 16.

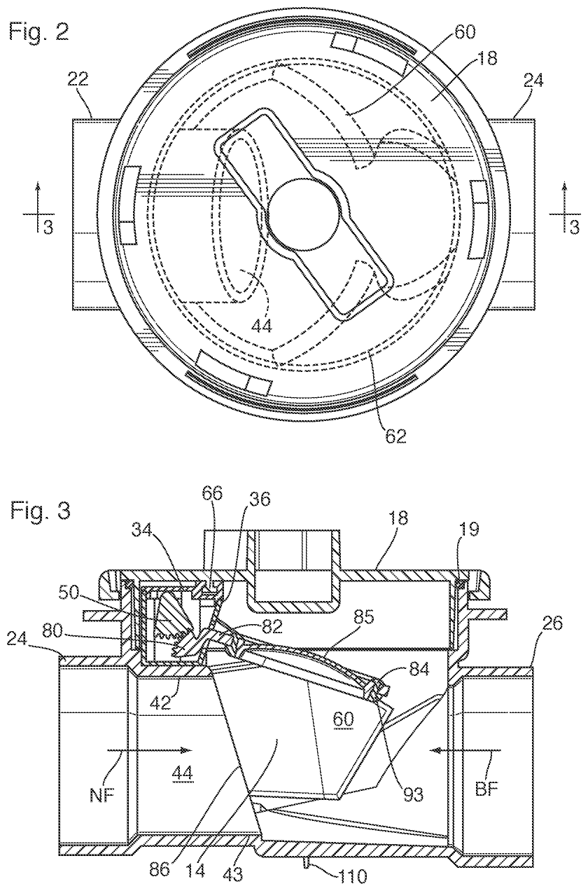

The valve body 12 includes an inflow end 24 and an outflow end 26, which are shown more clearly in FIG. 2. Each end 24, 26 may be formed with a bell type connection 27, sized and shaped to connect to a conventional sewage drainpipe will be understood by those skilled in the art. When the valve body 12 is connected to a sewage drainage system, the outflow end 26 is the end through which sewage backflow can enter the chamber 14. This invention is directed to preventing sewage backflow entering the chamber 14 through the outflow end 26 from progressing through the chamber and up the drainpipe towards the building as explained in more detail below.

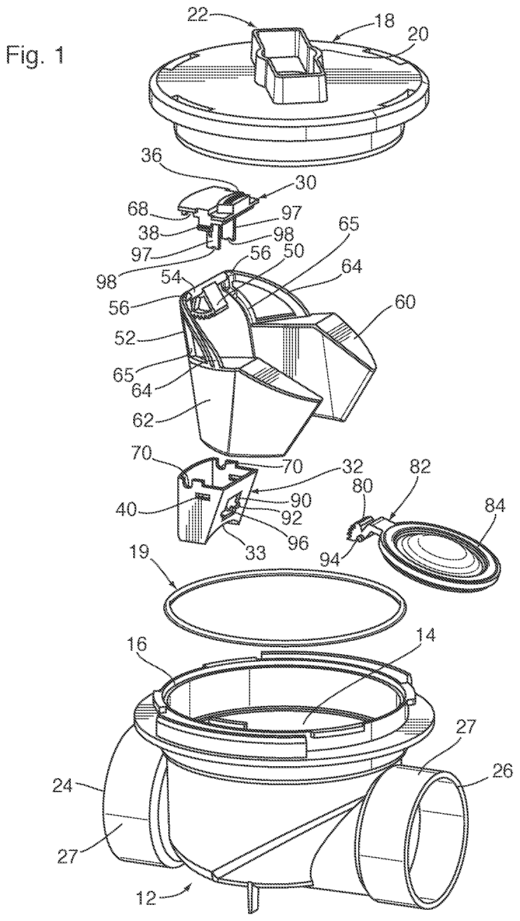

A number of the working elements which in combination help prevent sewage backflow are shown in FIG. 1 and can now be described. A gear box cover 30 clips onto a gear box body 32 to form a gear box 34. The cover 30 includes an arcuate (in top view) slot 36, described in more detail below, formed into a top surface thereof. Clips 38 in the cover 30 may be press fit into slots 40 in the gear box body 32 to secure the cover 30 onto the body 32. The body 32 includes a lower curved surface 33 to sit on top of a top 42 of an inflow channel 44 (FIGS. 2, 3) which extends into the flow through chamber 14 from the inflow end 24. The gear box 34 of the present invention substantially encloses and protects a pair of meshed gears, including a float gear 50 and a valve gear 80 when assembled from debris or the like interfering with the smooth operation of gears 50, 80 as explained in more detail below.

The float gear 50 is attached to a wishbone arm 52. An axle 54 extends laterally outwardly from either side of the float gear 50 to form part of the wishbone arm 52 and the ends of the axle 56 are attached to opposed floats 60, 62. In one form of the present invention the wishbone arm 52 may include spaced apart struts 64, 65 between the ends of the axle 54 and the floats 60, 62.

It can now be appreciated that the gear box cover 30 includes downwardly facing semi-circular openings 68 and the gear box body 32 includes upwardly facing semi-circular openings 70. When the cover 30 is clipped to the gear box body 32, the axle 56 is captured between the openings 68, 70 on either side to keep the axle 56 in place while also permitting the axle 56 to rotate within a bearing surface defined by the opposed openings 68, 70.

Also shown is the flapper valve gear 80 attached to a flapper valve lever arm 82 which in turn ends in the flapper valve 84. Most preferably the flapper valve lever arm 82 is located along the centre line of the flow through chamber to permit the flapper valve 84 to easily be centred to seal onto an inclined valve seat 86 (FIG. 3) formed on the valve body 12. The gear box body 32 includes a central window 90 through which the flapper valve gear 80 can fit. Notches 92 in the window 90 permit posts 94 to pass through the window 90. A semi-circular bearing seat 96 is formed on either lateral side of the gear box body 32 to seat the posts 94. Extending down from the gear box cover 30 are a pair of tabs 97 which have downwardly facing semi-circular bearing surfaces 98. The bearing surfaces 98 are sized and shaped to line up with the bearing seats 96 to capture the posts 94 therebetween. In this way the lever arm 82 and flapper valve 84 can rotate about the posts 94 which form a flapper valve pivot axis.

FIG. 2 is a top view of the present invention in an assembled position. Below the cover 18 is shown the inflow channel 44 and the opposed floats 60, 62. It can now be understood that the floats are sized and shaped to fit into the flow through chamber 14 on either side of the flow through chamber 14. The gear box 34 is also shown. FIG. 2 includes cut line A-A, which is shown in FIG. 3.

FIG. 3 shows a cross-sectional view of the working components in their functional positions in a normal flow draining condition. The gear box 34 is captured between the cover 18 and the top 42 of inflow channel 44. The float arm gear 50 is located within the gear box 34. The flapper valve gear 80 is meshed with the float arm gear 50 in the gear box 34. The flapper valve gear 80 is connected to the flapper valve 84 by the flapper valve lever arm 82. The slot 36 is shown as well as an upside-down T-shaped post 66, which is attached to the cover 18. The inflow end 24 and the outflow end 26 of the valve body 12 are shown on opposite sides of the flow through chamber 14. The float 60 is also shown.

The flow through chamber 14 includes the inflow channel 44 which has a shorter top 42 and a longer bottom 43. The inclined valve seat 86 extends between the top 42 and the bottom 43 of the inflow channel 44. It will be understood that the angled valve seat 86 defines an oval. The flapper valve 84 is sized and shaped to be able to seal against the oval valve seat 86. An O-ring seal 93 is preferably provided to help make this seal. The flapper valve 84 may be domed or bowed for strength and to help direct backwater fluid pressure onto the valve seat 86 during a backwater event as explained in more detail below.

FIG. 3 shows a cross-sectional view of the valve 12 with the working elements in the normal draining position. In this case there is no blockage downstream in the drainage system and so wastewater flows through the flow through chamber 14 in an unrestricted fashion in the direction of arrow W. The wastewater drains through the flow through chamber 14 as fast as it is received. In this case the floats 60, 62 remain in a lower position as shown, causing the flapper valve 84 to remain up as shown. It will be understood that the weight of the floats 60, 62 is sufficient to keep the flapper valve 84 in a raised position located up and off the valve seat thereby offering unrestricted liquid flow through the inflow channel 44. In addition, by placing the floats 60, 62 on either side of the chamber 14, the present invention provides for unobstructed flow through the valve body between the floats; in other words, the floats 60, 62 are off to the side of the normal flow NF and do not create any obstacles that could cause materials to get caught and create a potential blockage in the chamber 14. The arrow labelled BF shows the direction of flow in a backwater event. Another preferred aspect of the present invention is that the floats 60, 62 are sized and shaped to permit the flapper valve 84 to move up and down between the floats 60, 62 as the floats 60, 62 rise up and the valve 84 is lowered onto the valve seat 86 or vice versa. The internal faces of the floats 60, 62 are shaped to permit the flapper valve 84 to pass therebetween. In this way a short valve body 12 can be employed, reducing the overall footprint of the valve body 12.

Preferably the floats are made hollow for example from molded plastic that will retain its buoyancy over the long term. It is preferred to use materials which reduce the risk of the floats becoming water logged as may happen for example with floats made of Styrofoam of the like. The outside faces of the floats are also sized and shaped to fit within the curved side walls of the inflow chamber, (FIG. 2) thereby allowing a smaller valve body 12 footprint. Having two floats, 60, 62, one located on either end of the axle 56, allows a large float displacement volume within a relatively small flow through chamber 14. Reducing the overall valve body size 12 permits an easier installation in a retrofit application for the present invention as the hole in the basement floor and the hole in the ground beneath the floor within which to place the valve body need not be as big as for a wider or longer bodied valve.

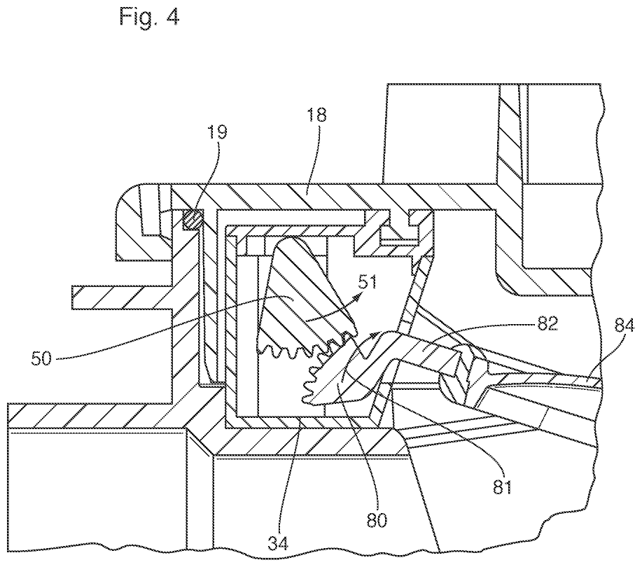

FIG. 4 is a close-up view of the gear box 34, and associated elements. The cover 18 is shown with the O-ring seal 19. The gear box cover 30 is shown with the slot 36 and the upside down T-shaped post 66. The valve gear 80 is connected to the valve arm 82 which extends into the gear box 34. The float valve gear 50 is shown meshing with the valve gear 80. Rotation of the float gear 50 in the direction of arrow 51 causes valve gear 80 to rotate in the direction of arrow 81. Domed valve 84 is shown.

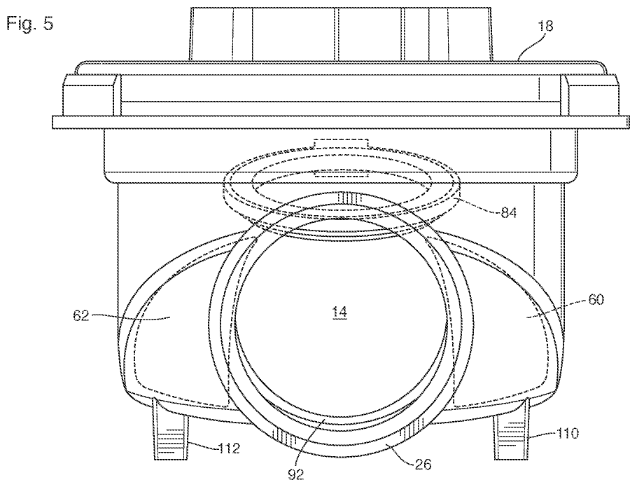

FIG. 5 is an end view looking through the outlet end 26 into the flow through chamber 14. A pair of stabilizing feet 110, 112 are shown. These may be pressed into the ground to help secure the valve body 12 in place. The floats 60, 62 are shown in a lowered position and the valve 84 is shown in the raised position. The valve seat 86 is also shown as well as the cover 18 and O-ring 19. As shown more clearly in this view, the valve 84 has room between the floats 60, 62 to move onto and off the valve seat 86.

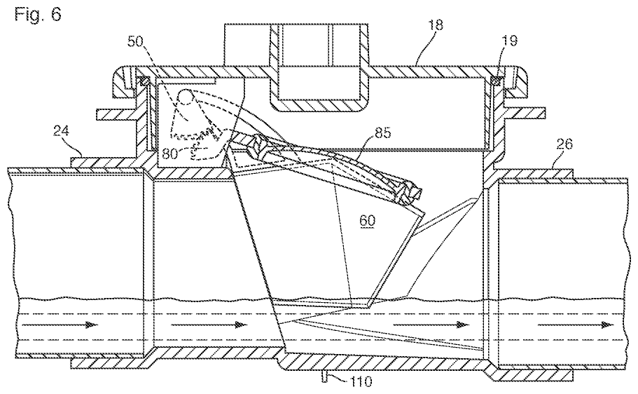

The operation of the present invention can now be more clearly understood. In FIG. 6 a flow of wastewater in the normal draining direction is shown. The wastewater flows from the inlet side, through the inflow channel through the flow through chamber and then out the outflow end. This is indicated by the arrows 300. As can be seen the level of the wastewater flow is low enough that the floats remain in a lowered position, keeping the flapper valve in a raised position and allowing the vapours to be vented upwardly, in a direction opposite to the wastewater flow.

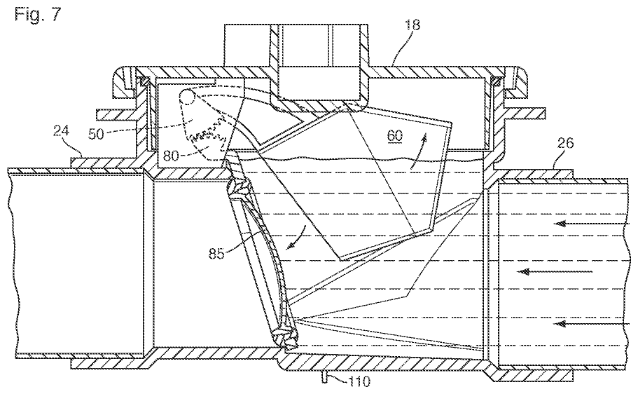

In the event of a wastewater backup, the liquid level in the flow through chamber 14 will rise, and so too will the floats 60, 62 as shown in FIG. 7. As the floats rise, the axle 54 rotates causing the float gear 50 to rotate upwardly. This in turn causes the flapper gear 80 to rotate upwardly, rotating the lever arm 82 about the posts 94 and driving the flapper valve 84 down by means of the lever arm 82. The more the chamber 14 fills with water the higher the floats 60, 62 go and the more the axle 54 rotates. Eventually the flapper valve 84 is pivoted down until the flapper valve 84 seats on the valve seat 86 thereby sealing the flow through chamber 14 against any back flow through the chamber 14 and up the drainpipes to the residence. In the preferred embodiment the axis of rotation of the float gear is above the float gear, whereas the axis of rotation of the valve gear is below the valve gear as shown in FIG. 3.

As can now be understood the floats will rotate the axle 56 through a range of rotation which is defined by the characteristics of the floats 60, 62 and the shape of the flow through chamber 14; eventually the floats 60, 62 will impinge of the top of the flow chamber 14 and will not rotate any more even if the chamber fills up to a deeper liquid level. In turn the flapper valve 84 has a defined range of motion which is determined by the difference between the raised position and the sealed position. It can now be understood that the present invention comprehends providing an appropriate gear ratio between the teeth of the float gear and the valve gear so that even though the degrees of rotation may not be identical, when the floats have risen, the valve has been pivoted into a seated and sealed position on the valve seat 86. However, most preferably the gear ratio is one to one, meaning that the amount of rotation of the float gear 50 is about equal to the amount of rotation of the valve gear 80. It will be understood that once the valve 84 has closed onto the valve seat 86 any further backwater pressure will simply cause the valve 84 to seat more tightly onto the valve seat 86. The only case where the valve 84 will be lifted off the valve seat 86 is when the chamber 14 drains and the floats 60, 62 drop back down to the lowered position depicted in FIG. 3.

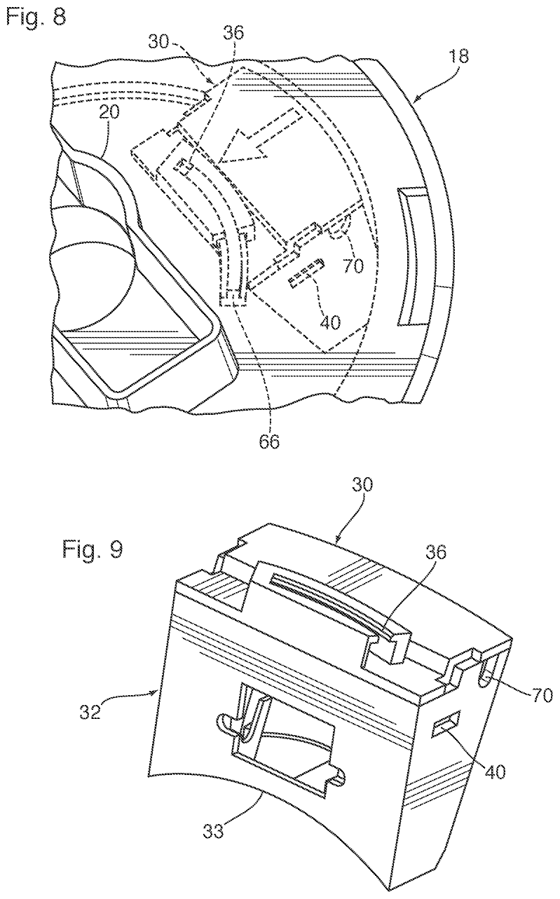

Another aspect of the present invention can now be described. In FIG. 8 cover 18 is shown with the upside-down T-shaped post 66 which extends below the cover 18. The T-shaped post 66 mates with the arcuate slot 36 (FIG. 9) formed on top of a gear box 34. The slot is arcuate to accommodate movement of the upside-down T-shaped post being moved through an arc as the cover 18 is rotated to fasten or release the cover 18 onto the access opening 16. It will also be noted that the post 66 is also arcuate when viewed from above to smoothly fit into the arcuate slot 36. A number of working elements may be connected to the gear box 34 as previously described. The arcuate slot 36 and the T-shaped post 66 are sized and shaped so that as the cover 18 is rotated, the T-shaped post 92 slides out into or out of engagement with arcuate slot 36 as shown in FIG. 8. According to the present invention, when the cover 18 is secured to the access opening, the T-shaped post 66 is out of engagement with the slot 36. Conversely, when the cover 18 is twisted to be loosened off the access opening 16, the T-shaped post 66 becomes engaged or trapped in the slot 36, meaning that when the cover 18 is turned and raised off the access opening 16 any working components connected to the slot 36 and gear box 34 will also be lifted up.

The preferred working components of the present invention consist of the gear box body 32, with the cover 30, that form the gear box 34 and that houses the geared connection between the wishbone float lever arm 52 and the flapper valve arm 82 together with the flapper valve 84 and the floats 60, 62. The gear box 34 surrounds the gear interface to prevent debris and the like from being able to interfere with the smooth operation of the gears. The gear box 34 also locks the gears into an engaging position so they can interact together as described above.

It can now be understood that when the valve 12 of the present invention needs to be serviced, all that is required is to rotate the cover 18, preferably a quarter turn, to a release position. As the cover is rotated to an open position the T-shaped post engages in the slot. Then the cover can be lifted up off of the access opening and the gear box can be lifted up through the access opening. The working components attached to the gear box 34 including the floats and the flapper valve are also lifted up out of the flow through chamber, allowing all of the elements to be inspected, repaired, cleaned or otherwise serviced as needed. Thus, the present invention provides an efficient way to service the working components that make up the backwater valve.

When it is time to reassemble the device all that is needed is to lower the cover into position and to thread the working components into the flow through chamber 14 through the access opening 16. The gear box 34 must seat onto the curved top 42 of the inlet flow channel 44 for the cover 18 to be able to be rotated and sealed to the access opening 16. In this way the present invention ensures that the floats and the valve are positioned correctly within the flow through chamber 14 and will function properly when servicing is complete, and the cap is securely resealed onto the access opening. The gear box 34 is positioned above the top 42 of the inflow channel 44. Preferably the gear box 34 is sized and shaped to be closely received in the space between the cover 18 and the top 42 of the inflow channel 44, so that the gear box 34 is securely held in position once the cover 18 is secured to the access opening 16.

While reference has been made to various preferred embodiments of the invention other variations, implementations, modifications, alterations and embodiments are comprehended by the broad scope of the appended claims. Some of these have been discussed in detail in this specification and others will be apparent to those skilled in the art, including different lengths of rotational travel between the floats and the flapper valve which may be accommodated by different gear ratios between the float gear and the valve gear. Those of ordinary skill in the art having access to the teachings herein will recognize these additional variations, implementations, modifications, alterations, and embodiments, all of which are within the scope of the present invention, which invention is limited only by the appended claims. What is believed to be important is to provide a backwater prevention valve having a compact footprint by placing the flapper valve between opposed floats and to allow for easy servicing by providing a quarter turn cover on the access opening which when removed simultaneously removes the working components.

What is claimed is:

1. A normally open backwater prevention valve for connecting to a sanitary drainpipe, said valve comprising:
an inflow end to connect to an upstream part of the drainpipe, and an out-flow end to connect to a downstream part of the drainpipe;
a main body defining a flow through chamber extending between said inflow and said out-flow ends;
a valve seat formed on an upstream side of said main body, said valve seat facing downstream;
a float assembly having opposed floats on opposite sides of the flow through chamber;
a check valve assembly including at least a valve member located between said opposed floats and being sized and shaped to seal on said valve seat, said check valve assembly further being operatively connected to said float assembly in a gear box wherein when said floats are down said valve member is in an open position and when said floats are up said valve member is in a closed position on said valve seat;
an access opening on a top of said flow through chamber; and
a removable cover for sealing said access opening.

2. The normally open back water prevention valve of claim 1 wherein said float assembly, check valve assembly and said gear box are sized and shaped to be removed from said chamber through said opening.

3. The normally open back water prevention valve of claim 1 further including an inflow channel extending into said flow through chamber from said inflow end.

4. The normally open back water prevention valve of claim 2 wherein said inflow channel is generally circular in cross section.

5. The normally open back water prevention valve of claim 2 wherein an end of said inflow channel defines said valve seat, said valve seat being inclined.

6. The normally open back water prevention valve of claim 4 wherein a top of said valve seat is closer to the inflow end than a bottom of the valve seat.

7. The normally open back water prevention valve of claim 1 wherein said check valve assembly includes a valve gear, a valve lever arm and a flapper valve.

8. The normally open back water prevention valve of claim 6 wherein said flapper valve includes a sealing gasket to seal against said valve seat.

9. The normally open back water prevention valve of claim 1 wherein said float assembly includes a float gear, a pair of opposed floats and a wishbone float arm.

10. The normally open back water prevention valve of claim 1 wherein said check valve assembly includes a valve gear, a valve lever arm and a flapper valve and said float assembly includes a float gear, a pair of opposed floats and a wishbone float arm.

11. The normally open back water prevention valve of claim 9 wherein said valve gear meshes with said float gear in said gear box.

12. The normally open back water prevention valve of claim 10 wherein a gear ratio is provided for said float and valve gears and when said floats are raised, said flapper valve seals on said valve seat, and where said floats are lowered said flapper valve rises clear of said valve seat.

13. The normally open backwater prevention valve as claimed in claim 11 wherein the gear ratio is 1 to 1.

14. The normally open back water prevention valve of claim 11 wherein said gear box is comprised of a gear box cover and a gear box body.

15. The normally open back water prevention valve of claim 12 wherein said gear box body includes a window to permit the flapper valve gear to be inserted into said gear box through said window.

16. The normally open back water prevention valve of claim 13 wherein said gear box cover may be press fit into a locking engagement with said gear box body.

17. The normally open back water prevention valve of claim 14 wherein bearing surfaces are defined between said gear box top and said gear box body to provide pivoting axes for said wishbone arm and said lever arm.

18. The normally open back water prevention valve of claim 1 wherein said opposed floats are hollow plastic moulded floats.

19. The normally open back water prevention valve of claim 16 wherein said opposed floats weigh more than said flapper valve to cause said flapper valve to be in a raised position when said opposed floats are in a lowered position due to gravity.

20. The normally open back water prevention valve of claim 17 wherein said opposed floats have a displacement volume sufficient to lower said flapper valve onto said valve seat when said opposed floats are floating due to buoyancy.

21. The normally open back water prevention valve of claim 16 wherein said opposed floats are sized and shaped to permit said flapper valve to move up and down between said opposed floats.

22. The normally open back water prevention valve of claim 19 wherein said opposed floats are generally curved to fit along a portion of a perimeter of said flow through chamber.

23. A normally open backwater prevention valve for connecting to a sanitary drainpipe, said valve comprising:
an inflow end to connect to an upstream part of the drainpipe, and an out-flow end to connect to a downstream part of the drainpipe;
a main body defining a flow through chamber extending between said inflow and said out-flow ends;
a valve seat formed on an upstream side of said main body, said valve seat facing downstream;
a float assembly having opposed floats on opposite sides of the flow through chamber;
a check valve assembly having a valve member located between said opposed floats and being sized and shaped to seal on said valve seat, said check valve assembly further being operatively connected to said float assembly wherein when said floats are down said valve member is in an open position and when said floats are up said valve member is in a closed position on said valve seat;
an opening on the top of said chamber; and
a removable cover for sealing and unsealing said opening;
wherein said float assembly, check valve assembly and said gear box are connected to said top when said top is in an open position and can be removed from said chamber by said connection.

24. The normally open backwater prevention valve for connecting to a sanitary drainpipe as claimed in claim 23 wherein said inflow channel includes a rounded top surface and said gear box includes a mating rounded bottom surface.

25. The normally open backwater prevention valve for connecting to a sanitary drainpipe of claim 24 wherein said gear box includes a slot on a top surface thereof.

26. The normally open backwater prevention valve for connecting to a sanitary drainpipe as claimed in claim 25 wherein said removable cover includes a T-shape post for engaging with said slot.

27. The normally open backwater prevention valve for connecting to a sanitary drainpipe of claim 26 wherein when said cover is rotated to a remove position, said T-shaped post engages in said slot.

28. The normally open backwater prevention valve for connecting to a sanitary drainpipe of claim 27 wherein said check valve assembly and said float assembly are connected to said gear box.

29. The normally open backwater prevention valve for connecting to a sanitary drainpipe of claim 28 wherein said check valve assembly and said float assembly and said gear box are sized and shaped to be removed from said flow through chamber as said cover is lifted off said access opening.

30. The normally open backwater prevention valve for connecting to a sanitary drainpipe of claim 29 wherein said floats have generally curved inward faces in plan view to accommodate said flapper valve therebetween.

31. The normally open backwater prevention valve for connecting to a sanitary drainpipe of claim 29 wherein said floats have generally curved outer faces in plan view to fit inside a curved outer wall of said flow through chamber.

32. The normally open backwater prevention valve for connecting to a sanitary drainpipe of claim 31 wherein said curved outer walls of said floats are sized to fit though said access opening.
